(19) United States
(12) Patent Application Publication
(10) Pub. No.: US 2025/0070606 A1
(43) Pub. Date: Feb. 27, 2025

(54) ROTOR HOUSING

(71) Applicants: DENSO CORPORATION, Kariya-city (JP); TOPY KOGYO KABUSHIKI KAISHA, Tokyo (JP)

(72) Inventors: HIROYUKI TSUCHIYA, Kariya-city (JP); KOJI KATO, Toyohashi-shi (JP)

(21) Appl. No.: 18/948,103

(22) Filed: Nov. 14, 2024

Related U.S. Application Data
(63) Continuation of application No. PCT/JP2023/015733, filed on Apr. 20, 2023.

(30) Foreign Application Priority Data
May 17, 2022 (JP) 2022-081042

(51) Int. Cl. H02K 1/28

(52) U.S. Cl. CPC H02K 1/28

(57) ABSTRACT

A rotor of a rotating electric machine has a rotor housing and a magnet. The rotor housing is cylindrical and includes a cylindrical portion that holds the magnet of the rotor, and an end plate portion that is joined to an axial end of the cylindrical portion and to which a shaft, which is a rotating axis, is fixed. The cylindrical portion and the end plate portion are formed separately and are joined together to form an integral body.

### CROSS REFERENCE TO RELATED APPLICATIONS

This application is a continuation application of International Patent Application No. PCT/JP2023/015773 filed on Apr. 20, 2023, which designated the U.S. and based on and claims the benefits of priority of Japanese Patent Application No. 2022-081042 filed on May 17, 2022.

### TECHNICAL FIELD

The disclosure in this specification relates to a rotor housing used in a rotating electric machine.

### BACKGROUND ART

A rotor has a configuration including a circular first core portion, a magnet provided on an inner circumference of the first core portion, and a second core portion fixed to the inner circumference of the first core portion and covering a circumferential end of the magnet from the opposite side to the first core portion.

### SUMMARY

The present disclosure has an object to provide a rotor housing that can suitably respond to various demands.

As for first aspect, a rotor housing used for a rotor of a rotating electric machine includes a cylindrical portion that is cylindrical and holds a magnet of the rotor, and an end plate portion joined to an axial end of the cylindrical portion and to which a shaft serving as a rotating shaft is fixed. The cylindrical portion and the end plate portion are formed separately and are joined together to form an integral body.

### BRIEF DESCRIPTION OF THE DRAWINGS

The above and other objects, features and advantages of the present disclosure will become more apparent from the following detailed description made with reference to the accompanying drawings. In the drawings:

FIGS. 1A and 1B are perspective views showing an overview of a rotor;

FIG. 2 is a longitudinal sectional view of a rotor;

FIG. 3 is an exploded cross-sectional view of a rotor housing;

FIG. 4 is a cross-sectional view showing a configuration of a joint between a cylindrical portion and an end plate portion;

FIGS. 5A to 5D are cross-sectional views showing a configuration of a joint between a cylindrical portion and an end plate portion;

FIG. 6 is a cross-sectional view showing a configuration of a joint between a cylindrical portion and an expanded diameter portion;

FIGS. 7A and 7B are vertical cross-sectional views of a rotor;

FIG. 8 is a vertical cross-sectional view of a rotor housing; and

FIG. 9 is a vertical cross-sectional view of a rotor housing.

### DETAILED DESCRIPTION

In an assumable example, a rotor has a configuration including a circular first core portion, a magnet provided on an inner circumference of the first core portion, and a second core portion fixed to the inner circumference of the first core portion and covering a circumferential end of the magnet from the opposite side to the first core portion. Also, a configuration is described in which a connecting portion that connects the first core portion to a rotating shaft is fixed to an axial end portion of the first core portion.

Various requirements arise for the rotating electric machine, for example with regard to performance. Furthermore, there is concern that manufacturing rotors individually to meet the various requirements of rotating electric machines will require increased effort and cost. In particular, the rotor housing is a component that generates centrifugal force and vibration as it rotates, and there is a demand for technology that can appropriately respond even if the centrifugal force and vibration change due to changes in performance requirements.

The present disclosure has been made in consideration of the above circumstances, and has an object to provide a rotor housing that can suitably respond to various demands.

The disclosed aspects in this description adopt different technical solutions from each other in order to achieve their respective objectives. The objects, features, and effects disclosed herein will become more apparent from the following detailed description and the accompanying drawings.

As for first aspect, a rotor housing used for a rotor of a rotating electric machine includes a cylindrical portion that is cylindrical and holds a magnet of the rotor, and an end plate portion joined to an axial end of the cylindrical portion and to which a shaft serving as a rotating shaft is fixed. The cylindrical portion and the end plate portion are formed separately and are joined together to form an integral body.

In the rotor, the cylindrical portion that holds the magnet and the end plate portion to which the rotating shaft is fixed are formed as a single unit. However, when the performance requirements and applications of the rotating electric machine differ, the performance required of the cylindrical portion and the end plate portion differs. In this regard, since the cylindrical portion and the end plate portion are formed separately and then joined together to form an integrated body, it is easy to respond to variations in response to the performance requirements and applications of the rotating electric machine. As a result, it is possible to realize the rotor housing that can suitably meet various requirements.

In a second aspect, the cylindrical portion and the end plate portion are integrated together with a joint portion on the cylindrical portion side and a joint portion on the end plate portion side being fitted together in a radial direction.

The cylindrical portion and the end plate portion are integrated together with the joint portion on the cylindrical portion side and the joint portion on the end plate portion side fitted together in the radial direction. In this case, the precision of the coaxiality between the cylindrical portion and the end plate portion is improved.

In a third aspect, in the rotor housing in which the magnet is attached to the radially inner side of the cylindrical portion, the cylindrical portion and the end plate portion are joined together with a joint portion on the cylindrical portion side facing on radially outer side and a joint portion on the end plate portion side facing on radially inner side.

The cylindrical portion and the end plate portion are joined together with the joint portion on the cylindrical portion side facing on the radially outer side and the joint portion on the end plate portion 14 side facing on the radially inner side. In this case, in the rotor, the axial end face of the end plate portion joined to the radially inner side of the cylindrical portion faces the axial end face of the magnet. This makes it possible to position the magnet in an axial direction by the end plate portion.

In a fourth aspect, in the rotor housing in which the magnet is attached to the radially inner side of the cylindrical portion, the cylindrical portion and the end plate portion are joined together with a joint portion on the cylindrical portion side facing on radially inner side and a joint portion on the end plate portion side facing on radially outer side.

The cylindrical portion and the end plate portion are joined to each other with the joint portion on the cylindrical portion side facing on radially inner side and the joint portion on the end plate portion side facing on radially outer side. Therefore, when centrifugal force is applied to the cylindrical portion which holds the magnet when the rotor rotates, the centrifugal force can be preferably supported by the end plate portion on the radially outer side of the cylindrical portion.

In a fifth aspect, the end plate portion has a circular annular portion extending in the axial direction, and the cylindrical portion has a protruding portion at its axial end that protrudes radially inward, and a circular annular fitting portion extending in the axial direction is provided at the radial end of the protruding portion, and the cylindrical portion and the end plate portion are fitted together with a fitting portion, which is the joint portion on the cylindrical portion side, on the radially inner side, and the annular portion, which is the joint portion on the end plate portion side, on the radially outer side.

In the above configuration, the cylindrical portion and the end plate portion are fitted together with the mating portion, which is the joint portion on the cylindrical portion side, on the radially inner side and the annular portion, which is the joint portion on the end plate portion side, on the radially outer side, thereby further improving the coaxial precision of the cylindrical portion and the end plate portion.

In a sixth aspect, when the cylindrical portion and the end plate portion overlap each other with the joint portion on the cylindrical portion side facing on a radially inner side and the joint portion on the end plate portion side facing on a radially outer side, the end plate portion overlaps the cylindrical portion and the magnet in the radial direction.

According to the above configuration, the joint portion of the end plate portion overlaps the joint portion on the cylindrical portion side in the radial direction, and also overlaps the magnet on the inner side of the cylindrical portion, so that the centrifugal force of the magnet is effectively supported by the end plate portion when the rotor rotates.

In a seventh aspect, the cylindrical portion is made of a magnetic material, and the end plate portion is made of a material which is non-magnetic and lighter than the cylindrical portion.

According to the above-described configuration, the cylindrical portion necessary for a magnetic circuit is made of a magnetic material, and the end plate portion is made of a lightweight non-magnetic material (for example, aluminum), thereby making it possible to reduce weight while ensuring proper rotor function.

In an eighth aspect, a cylindrical extension portion is provided at an end of the cylindrical portion opposite the end plate portion in the axial direction, extending axially outward from a magnet arrangement area, and the cylindrical portion and the cylindrical extension portion are each formed separately and are integrated by joining them together.

In the above-described configuration, the rotor housing is provided with the cylindrical extension portion separate from the cylindrical portion, and the cylindrical extension portion is joined to the axial end of the cylindrical portion. In this case, even if the shape of the component attached to the end of the rotor housing on the opposite side in the axial direction to the end plate portion is changed as appropriate, the change can be appropriately accommodated.

In a ninth aspect, the end plate portion has a disk portion extending in a direction perpendicular to the axial direction, and a shaft fixing portion provided on the radial center side of the circular plate portion and fixing the shaft, and the circular plate portion and the shaft fixing portion are each formed as separate bodies and are integrated by being joined together.

In the above configuration, the end plate portion of the rotor housing has a disk portion extending in a direction perpendicular to the axial direction and a shaft fixing portion provided on the center side in the radial direction of the disk portion, and the disk portion and the shaft fixing portion may be joined to each other. In this case, even if the shape of the shaft fixed to the end plate portion is changed as required, it is designed to be suitable for accommodating such changes effectively.

In a tenth aspect, the cylindrical portion and the end plate portion have different thicknesses, and the thickness of the cylindrical portion is greater than the thickness of the end plate portion.

In the rotor housing, in which the cylindrical portion and the end plate portion are formed separately, the thickness dimensions of the cylindrical portion and the end plate portion can be easily made different from each other. By making the thickness dimension of the cylindrical portion larger than the thickness dimension of the end plate portion, it is possible to suitably respond to cases where the strength requirement for the rotor in the rotating electric machine against the centrifugal force, for example, is high. Furthermore, since the thickness of the rotor housing is increased only at necessary parts, the rotor is prevented from becoming larger and heavier.

In an eleventh aspect, the cylindrical portion and the end plate portion have different thicknesses, and the thickness of the end plate portion is greater than the thickness of the cylindrical portion.

Since the thickness of the end plate portion is made larger than the thickness of the cylindrical portion, it is possible to suitably cope with cases where vibrations occurring around a shaft (rotating axis) in a rotating electric machine are large, for example.

Embodiments will be described below with reference to the drawings. A rotating electric machine is used, for example, as on-board electric device. However, the rotating electric machine may be widely used for industrial purposes, ships, aircraft, home appliances, OA equipment, game machines, and the like. The rotating electric machine according to the present embodiment is an outer rotor type surface permanent magnet motor, and as is well known, has a rotor and a stator. The rotor and the stator are disposed so as to face each other in a radial direction, and the rotor is rotatable about a rotation axis relative to the stator.

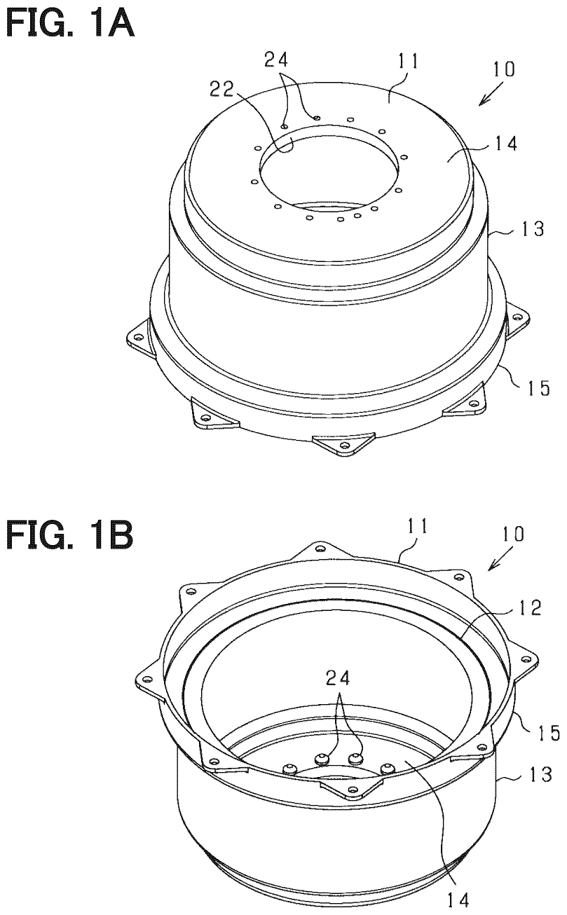

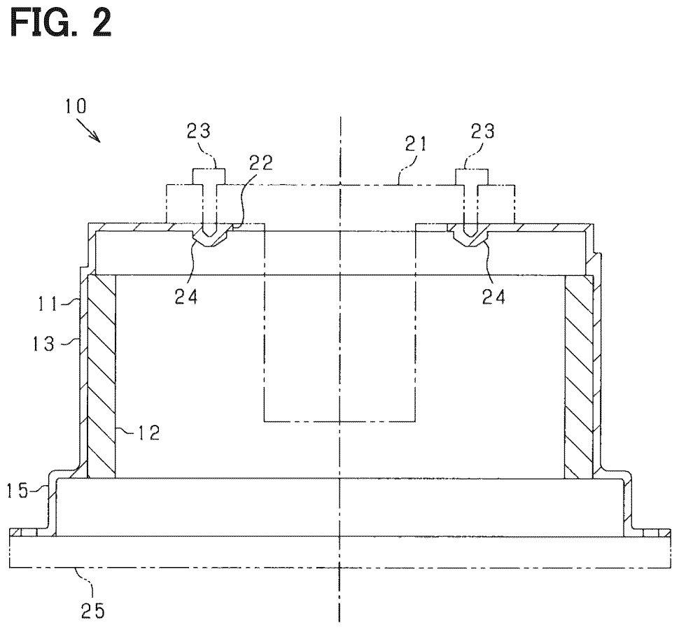

FIGS. 1A and 1B are perspective views showing an outline of a rotor 10, and FIG. 2 is a vertical cross-sectional view of the rotor 10. In FIG. 1A, FIG. 1B and FIG. 2, a direction in which the rotation axis of the rotor 10 extends (an up and down direction in the figures) is defined as an axial direction, a direction extending radially from a center of the rotation axis is defined as a radial direction, and a direction extending circumferentially around the rotation axis is defined as a circumferential direction.

The rotor 10 has a rotor housing 11 having a substantially cylindrical cup shape, and an annular magnet unit 12 fixed to the rotor housing 11. The rotor housing 11 has a cylindrical portion 13, an end plate portion 14 provided on one axial end side of the cylindrical portion 13, and an enlarged diameter portion 15 provided on the other axial end side of the cylindrical portion 13 and having a larger diameter than the cylindrical portion 13.

A magnet unit 12 is fixed to the radially inner side of the cylindrical portion 13. The other axial end side of the rotor housing 11 is open. The magnet unit 12 is composed of a plurality of magnets arranged in the circumferential direction of the rotor 10 so that their polarities alternate. As a result, the magnet unit 12 has a plurality of magnetic poles in the circumferential direction. The magnets are preferably provided divided into poles, and are arranged side by side so that their side surfaces in the circumferential direction face each other. The cylindrical portion 13 functions as a magnet holding member.

A shaft 21, which serves as the center of rotation of the rotor 10, is fixed to the end plate portion 14. Specifically, the end plate portion 14 has a hole portion 22 in the radial center, and a plurality of fastened portions 24 are provided around the hole portion 22 for fastening fasteners 23 such as bolts for fixing the shaft. The fastened portion 24 may be composed of a through hole that penetrates the end plate portion 14 in a plate thickness direction, and a nut (weld nut) fixed to the plate surface of the end plate portion 14. The shaft 21 is inserted through the hole portion 22 and fixed to the end plate portion 14 by the fastener 23. It is also possible to fix a rotating part, which is one of a stationary part and a rotating part such as ball bearings, to the end plate portion 14, and to fix the shaft 21 to the rotating part.

The end plate portion 14 and the enlarged diameter portion 15 are portions of the rotor housing 11 that are provided axially outward of the area in which the magnet unit 12 is disposed. The enlarged diameter portion 15 corresponds to the “cylindrical extension portion.” A closure plate 25 for closing the open end side of the rotor housing 11 is fixed to the enlarged diameter portion 15 by bolts or the like.

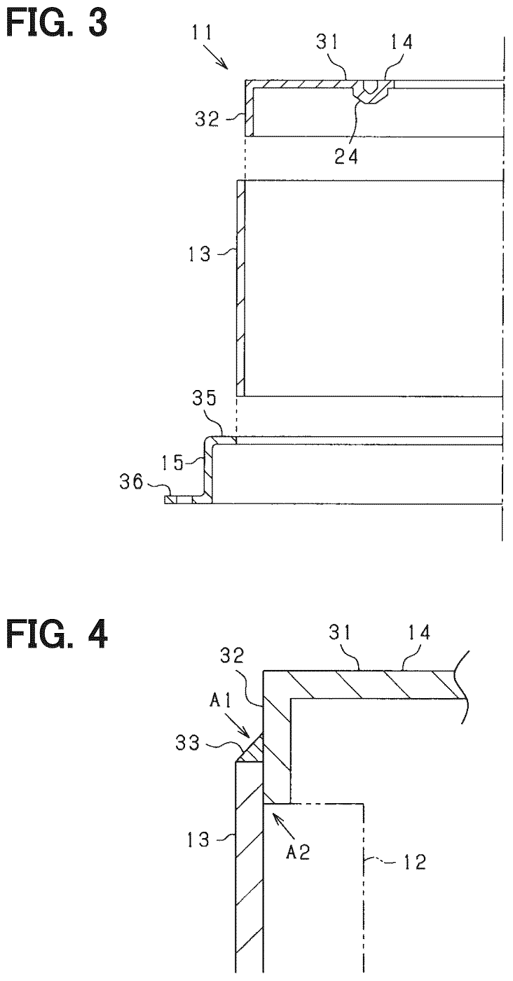

In the present embodiment, the cylindrical portion 13, the end plate portion 14, and the enlarged diameter portion 15 in the rotor housing 11 are each manufactured separately and joined together by a joining means such as welding or brazing, and the details of this are described below. FIG. 3 is an exploded cross-sectional view of the rotor housing 11.

The cylindrical portion 13 is made of a magnetic material, and is formed, for example, by bending an electromagnetic steel plate into a cylindrical shape and joining the circumferential ends of the plate material together by welding or the like. However, in addition to this configuration, it is also possible to use a configuration in which a plurality of electromagnetic steel plates punched into an annular shape are stacked in the axial direction as the cylindrical portion 13, or a configuration in which linear laminated steel plates are wound in a spiral shape and stacked in the axial direction. When the cylindrical portion 13 is made of a magnetic material, the cylindrical portion 13 functions as a rotor core.

The end plate portion 14 and the enlarged diameter portion 15 are made of a material that is non-magnetic and lighter than the cylindrical portion 13, and are formed by pressing, forging or casting aluminum, for example. The use of lightweight metals such as aluminum allows the rotor 10 to be lightweight. However, it is also possible to manufacture at least one of the end plate portion 14 and the enlarged diameter portion 15 from a magnetic material, similar to the cylindrical portion 13. The cylindrical portion 13, the end plate portion 14 and the enlarged diameter portion 15 may each be appropriately subjected to a surface treatment for rust prevention and corrosion resistance.

The end plate portion 14 includes a disk portion 31 having hollow and disk-shaped and a joint end portion 32 that extends in an annular shape from an outer circumferential edge portion of the disk portion 31 and is joined to the cylindrical portion 13. The disk portion 31 is provided with the plurality of fastened portions 24 described above. The joint end portion 32 extends in an annular shape in the axial direction, and a coil end portion of the stator coil is accommodated on an inner peripheral side of the joint end portion 32. The joint end portion 32 corresponds to an “annular portion.” The joint end portion 32 is a portion that constitutes the end portion on a radially outer circumferential side of the cylindrical portion 13, and the joint end portion 32 is joined to the cylindrical portion 13 by fitting in the radial direction. In the configuration of FIG. 3, the cylindrical portion 13 is on the radially outer side and the joining end portion 32 of the end plate portion 14 is on the radially inner side, and these two are fitted together.

A specific configuration is shown in FIG. 4. As shown in FIG. 4, the cylindrical portion 13 and the end plate portion 14 are assembled together such that their joint portions overlap in the radial direction. More specifically, the cylindrical portion 13 and the end plate portion 14 are assembled to each other such that the joint end portion 32 of the end plate portion 14 fits into the inner periphery of the cylindrical portion 13 (i.e., they are assembled to each other with the cylindrical portion 13 on the radially outer side and the end plate portion 14 on the radially inner side), and the joint surfaces of both portions are joined by brazing or welding.

Here, the joining of the cylindrical portion 13 and the end plate portion 14 is preferably performed over the entire circumferential direction on both the outer circumferential side and the inner circumferential side of the rotor housing 11 (as shown in the directions A1 and A2 in FIG. 4). This makes it possible to improve the strength and sealing performance of the rotor housing 11. In addition, the joint between the cylindrical portion 13 and the end plate portion 14 may be covered with a sealing material 33 such as a liquid gasket. As a result, even if the sealing performance of the joint between the cylindrical portion 13 and the end plate portion 14 is insufficient, this insufficiency in sealing performance can be adequately compensated for. Furthermore, when the cylindrical portion 13 and the end plate portion 14 are made of different metals, there is a concern that bimetallic corrosion (galvanic corrosion) may occur. However, since the joint portion is covered with the sealing material 33, the occurrence of bimetallic corrosion is suppressed.

In the configuration of FIG. 4, an axial end face of the end plate portion 14 joined to the radially inner side of the cylindrical portion 13 (more specifically, the axial end face of the joint end portion 32) faces the axial end face of the magnet unit 12. This makes it possible to position the magnet unit 12 in the axial direction by the end plate portion 14, eliminating the need for jigs or equipment for positioning the magnet unit 12 in the axial direction.

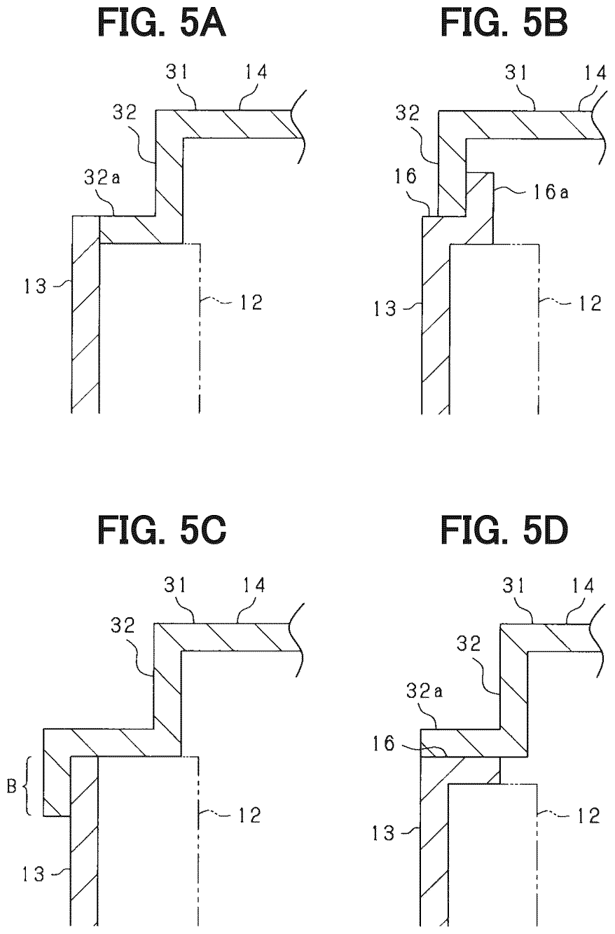

Moreover, the joint between the cylindrical portion 13 and the end plate portion 14 may be configured as shown in FIGS. 5A to 5D.

In FIG. 5A, similarly to FIG. 4, the cylindrical portion 13 and the end plate portion 14 are assembled to each other with the joint portion of the cylindrical portion 13 facing on the radially outer side and the joint portion of the end plate portion 14 facing on the radially inner side. However, the difference with the configuration in FIG. 4 is that an annular flange 32a extending radially outward is provided at the axial end of the joint end portion 32 of the end plate portion 14 opposite the disc portion 31, and the cylindrical portion 13 and the end plate portion 14 are assembled to each other so that the annular flange 32a fits into the radially inner side of the cylindrical portion 13.

In FIG. 5B, unlike FIG. 4, the cylindrical portion 13 and the end plate portion 14 are assembled to each other with the joint portion of the cylindrical portion 13 facing on the radially inner side and the joint portion of the end plate portion 14 facing on the radially outer side. In detail, a circular annular flange 16 is provided at the axial end of the cylindrical portion 13 so as to protrude radially inward, and the annular flange 16 has a reduced diameter portion 16a which is smaller in diameter than the cylindrical portion 13. The annular flange 16 corresponds to a “protruding portion”, and the reduced diameter portion 16a corresponds to a “fitting portion”. The joint end portion 32 of the end plate portion 14 is fitted into the radially outer side of the reduced diameter portion 16a. In short, the cylindrical portion 13 and the end plate portion 14 are joined to each other by a so-called spigot structure, with the joint portion of the cylindrical portion 13 facing radially inward and the joint portion of the end plate portion 14 facing radially outward. This improves the accuracy of the coaxiality between the cylindrical portion 13 and the end plate portion 14. Furthermore, since the cylindrical portion 13 is positioned radially inward and the end plate portion 14 is positioned radially outward, when centrifugal force is applied to the cylindrical portion 13 that holds the magnet unit 12 when the rotor 10 rotates, the centrifugal force is preferably supported by the end plate portion 14 on the radially outer side of the cylindrical portion 13.

The annular flange 16 may be formed by pressing or the like, for example, after the cylindrical portion 13 is formed. The annular flange 16 is provided at a location axially outward of the magnet fixing range where the magnet unit 12 is fixed radially inward in the cylindrical portion 13, and the annular flange 16 faces the axial end face of the magnet unit 12, making it possible to position the magnet unit 12 in the axial direction using the annular flange 16.

In FIG. 5C, similar to FIG. 5B, the cylindrical portion 13 and the end plate portion 14 are assembled to each other with the joint portion of the cylindrical portion 13 facing radially inward and the joint portion of the end plate portion 14 facing radially outward. In particular, in this configuration, the joint end portion 32 of the end plate portion 14 overlaps both the cylindrical portion 13 and the magnet unit 12 in the radial direction. Therefore, when the rotor 10 rotates, the centrifugal force acting on the magnet unit 12 is appropriately supported by the end plate portion 14.

In FIG. 5D, the joint portions of the cylindrical portion 13 and the end plate portion 14 are joined together in a state where they are overlapped in the axial direction. Specifically, the annular flange 16 on the cylindrical portion 13 side and the annular flange 32a on the end plate portion 14 side are joined to each other by brazing or the like in a state where they overlap in the axial direction.

The enlarged diameter portion 15 has an annular inner flange 35 and an outer flange 36, of which the inner flange 35 serves as a joining portion that is joined to the cylindrical portion 13. In the configuration of FIG. 3, the cylindrical portion 13 is positioned on the radially inner side, and the inner flange 35 of the enlarged diameter portion 15 is positioned on the radially outer side, and these two are fitted together.

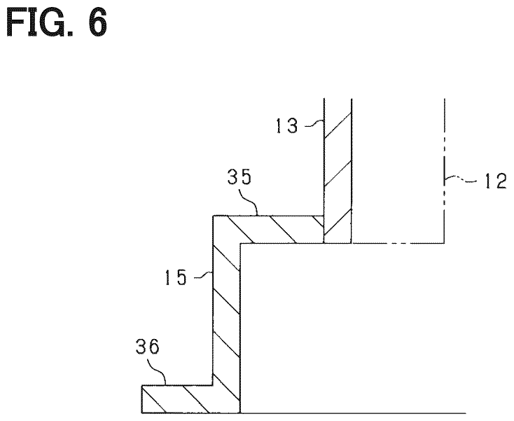

A specific configuration is shown in FIG. 6. As shown in FIG. 6, the cylindrical portion 13 and the enlarged diameter portion 15 are assembled together such that their joint portions overlap in the radial direction. More specifically, the cylindrical portion 13 and the enlarged diameter portion 15 are assembled to each other such that the inner flange 35 of the enlarged diameter portion 15 is fitted onto the outer periphery of the cylindrical portion 13 (i.e., they are assembled to each other with the cylindrical portion 13 on the radially inner side and the enlarged diameter portion 15 on the radially outer side), and the mating surfaces of both joint portions are joined by brazing or welding.

Incidentally, in the rotor 10, the magnitude of centrifugal force and vibration generated during operation of the rotating electric machine varies depending on the specifications, such as the performance and size, of the rotating electric machine. For example, the magnitude of the centrifugal force generated in the rotor 10 varies depending on the expected rotational speed of the rotating electric machine and the outer diameter (rotor diameter) of the rotor 10. Therefore, the higher the expected rotational speed of the rotating electric machine or the larger the rotor diameter, the greater the centrifugal force generated in the rotor 10. It is also considered that the centrifugal force changes depending on the amount of magnet in the magnet unit 12 and the thickness of the magnet. Furthermore, the magnitude of vibration generated in the shaft of the rotor 10 varies depending on, for example, the application of the rotating electric machine. When it is used as a driving power source in a vehicle, particularly as an in-wheel motor, the vibration will be large, and when it is used as a stationary device, the vibration will be relatively small.

In this regard, in the present embodiment, the thickness dimensions of the cylindrical portion 13, the end plate portion 14 and the enlarged diameter portion 15 of the rotor housing 11 can be individually selected according to the specifications of the rotating electric machine, such as its performance and size. For example, the cylindrical portion 13, the end plate portion 14, and the enlarged diameter portion 15 are each manufactured to have an optimal thickness, and then the rotor housing 11 is manufactured by integrating these portions. In addition, depending on the specifications of the rotating electric machine, the materials of the cylindrical portion 13, the end plate portion 14 and the expanded diameter portion 15 can be changed individually, and the materials of each of these portions can be made to have a high Young's modulus and high tensile strength as necessary.

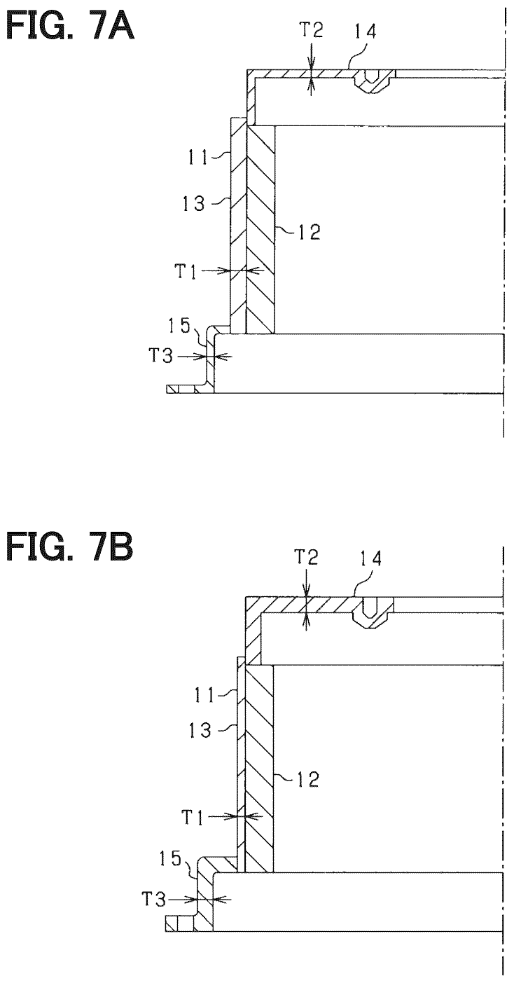

In the configuration shown in FIG. 7A, the thicknesses T1, T2, and T3 of the cylindrical portion 13, the end plate portion 14, and the enlarged diameter portion 15 are set to satisfy “T1>T2, T3”. In this case, of the cylindrical portion 13, the end plate portion 14 and the enlarged diameter portion 15, the thickness T1 of the cylindrical portion 13 is larger than the thicknesses T2, T3 of the other portions. This makes it possible to suitably cope with, for example, a case in which the rotor 10 in a rotating electric machine is required to have high strength against centrifugal forces.

In the configuration shown in FIG. 7B, the thicknesses T1, T2, and T3 of the cylindrical portion 13, the end plate portion 14, and the expanded diameter portion 15 are set to satisfy “T1<T2, T3”. In this case, of the cylindrical portion 13, the end plate portion 14 and the enlarged diameter portion 15, the thicknesses T2, T3 of the end plate portion 14 and the enlarged diameter portion 15 are greater than the thickness T1 of the cylindrical portion 13. This makes it possible to suitably deal with cases where vibrations occurring around the shaft of the rotating electric machine are large, for example. In addition, in FIGS. 7A and 7B, the thicknesses T2 and T3 may be the same or different.

When manufacturing the rotor 10, the cylindrical portion 13, the end plate portion 14, and the enlarged diameter portion 15, which are the components of the rotor housing 11, are each prepared in advance, and these components are joined together by a joining means such as brazing or welding. In this case, sealing is performed with a sealant 33 at the joint portions between the respective components as necessary. Here, the materials and thicknesses of the cylindrical portion 13, the end plate portion 14 and the enlarged diameter portion 15 are set in an appropriate combination pattern according to the specifications of the rotating electric machine, and then these respective components are joined together.

Thereafter, the magnet unit 12 is attached to the rotor housing 11 using an adhesive or the like. In this way, the rotor 10 shown in FIGS. 1 and 2 is completed. After the rotor 10 is completed, the shaft 21 is fixed, it is integrated with a stator (not shown), the closure plate 25 is fixed, and so on. In the rotor 10, the inner circumferential side of the end plate portion 14 and the inner circumferential side of the enlarged diameter portion 15 are adapted to accommodate coil end portions of the stator coil.

According to the present embodiment described in detail above, the following excellent effects can be obtained.

In the rotor 10, the cylindrical portion 13 that holds the magnet unit 12 and the end plate portion 14 to which the shaft 21 is fixed are formed as a single unit. However, when the performance requirements and applications of the rotating electric machine differ, the performance required of the cylindrical portion 13 and the end plate portion 14 will differ. In this regard, since the cylindrical portion 13 and the end plate portion 14 are formed separately and then joined together to form an integrated body, it is easy to respond to variations in response to the performance requirements and applications of the rotating electric machine. As a result, it is possible to realize the rotor housing 11 that can suitably meet various requirements.

The cylindrical portion 13 is a magnet holding portion that holds a magnet, and the end plate portion 14 is a coil end housing portion that houses the coil end portion of the stator coil. Therefore, the above configuration corresponds to a configuration in which the magnet holding portion and the coil end housing portion are formed separately in the rotor housing 11 and integrated by joining them together.

The cylindrical portion 13 and the end plate portion 14 are integrated together with the joint portion on the cylindrical portion 13 side and the joint portion on the end plate portion 14 side fitted together in the radial direction. In this case, the precision of the coaxiality between the cylindrical portion 13 and the end plate portion 14 is improved.

The cylindrical portion 13 and the end plate portion 14 are joined together with the joint portion on the cylindrical portion 13 side facing radially outward and the joint portion on the end plate portion 14 side facing radially inward (FIGS. 4 and 5A). In this case, the axial end face of the end plate portion 14 joined to the radially inner side of the cylindrical portion 13 faces the axial end face of the magnet unit 12. This makes it possible to position the magnet unit 12 in the axial direction by the end plate portion 14.

The cylindrical portion 13 and the end plate portion 14 are joined to each other with the joint portion on the cylindrical portion 13 side facing radially inward and the joint portion on the end plate portion 14 side facing radially outward (FIGS. 5B and 5C). Therefore, when centrifugal force is applied to the cylindrical portion 13 which holds the magnet unit 12 when the rotor 10 rotates, the centrifugal force can be preferably supported by the end plate portion 14 on the radially outer side of the cylindrical portion 13.

The cylindrical portion 13 and the end plate portion 14 are fitted together with the reduced diameter portion 16a (fitting portion), which is the joint portion on the cylindrical portion 13 side, on the radially inner side, and the joint end portion 32 (annular portion), which is the joint portion on the end plate portion 14 side, on the radially outer side (FIG. 5B). This further improves the accuracy of the coaxiality between the cylindrical portion 13 and the end plate portion 14.

The joint portion of the end plate portion 14 overlaps the joint portion on the cylindrical portion 13 side in the radial direction, and also overlaps the magnet unit 12 on the inner peripheral side of the cylindrical portion 13 (FIG. 5C). Therefore, when the rotor rotates, the centrifugal force acting on the magnet unit 12 is appropriately supported by the end plate portion 14.

In the rotor housing 11, the cylindrical portion 13 necessary for the magnetic circuit is made of a magnetic material, and the end plate portion 14 is made of a lightweight non-magnetic material (for example, aluminum), thereby making it possible to reduce weight while maintaining rotor function.

In the rotor housing 11 in which the enlarged diameter portion 15 is provided as a cylindrical extension portion extending axially outward beyond the magnet arrangement area at the end of the cylindrical portion 13 on the opposite side to the end plate portion 14 in the axial direction, the cylindrical portion 13 and the enlarged diameter portion 15 are each formed as separate members and are joined together. This makes it possible to appropriately accommodate any changes to the shape of the components attached to the end of the rotor housing 11 on the axially opposite side to the end plate portion 14.

In the rotor housing 11, in which the cylindrical portion 13 and the end plate portion 14 are formed separately, the thickness dimensions of the cylindrical portion 13 and the end plate portion 14 can be easily made different from each other. Here, by making the thickness dimension of the cylindrical portion 13 larger than the thickness dimension of the end plate portion 14, it is possible to suitably respond to cases where the strength requirement for the rotor 10 in the rotating electric machine against the centrifugal force, for example, is high. Furthermore, since the thickness of the rotor housing 11 is increased only at necessary parts, the rotor 10 is prevented from becoming larger and heavier.

In the rotor housing 11, by making the thickness dimension of the end plate portion 14 larger than the thickness dimension of the cylindrical portion 13, it is possible to suitably deal with cases where vibrations occurring around the shaft in the rotating electric machine are large, for example.

### Modifications

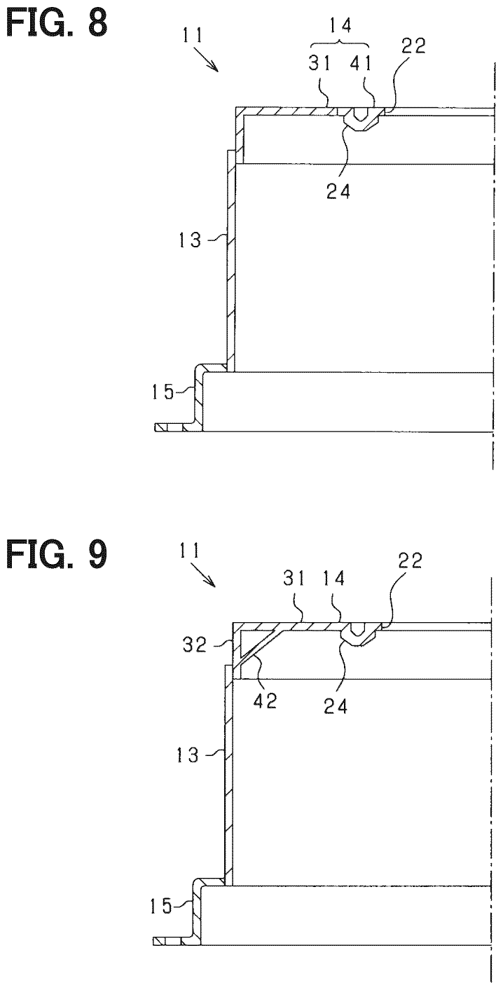

As shown in FIG. 8, the end plate portion 14 of the rotor housing 11 may have a disk portion 31 extending in a direction perpendicular to the axial direction and a shaft fixing portion 41 provided on the center side in the radial direction of the disk portion 31, and the disk portion 31 and the shaft fixing portion 41 may be joined to each other. The shaft fixing portion 41 may be provided with a plurality of fastened portions 24 each made of a nut (weld nut). The disk portion 31 and the shaft fixing portion 41 are formed separately and are integrated by being joined to each other. In this case, even if the shape of the shaft 21 fixed to the end plate portion 14 is changed as required, it is designed to be suitable for accommodating such changes effectively.

The cylindrical portion 13, the end plate portion 14, and the enlarged diameter portion 15 of the rotor housing 11 may each have a reinforcement structure according to the strength requirements of each portion. For example, in a configuration in which the cylindrical portion 13, the end plate portion 14, and the enlarged diameter portion 15 of the rotor housing 11 have corners (bent portions) that are bent in the radial direction, there is a concern about stress concentration at the corners. Taking this concern into consideration, it is advisable to provide reinforcement measures to increase the strength of the corners of the cylindrical portion 13, the end plate portion 14 and the enlarged diameter portion 15. For example, the corners of each component may be appropriately subjected to work hardening treatment such as bending.

Further, reinforcing ribs may be provided at the corners of the cylindrical portion 13, the end plate portion 14 and the enlarged diameter portion 15. Specifically, as shown in FIG. 9, a rib 42 may be provided on the end plate portion 14 so as to connect the disk portion 31 and the joint end portion 32. The rib 42 may be formed, for example, when the end plate portion 14 is cast.

In each of the above embodiments, a surface magnet type rotor is used as the rotor 10. However, instead of this configuration, an embedded magnet type rotor may be used. In the case of the embedded magnet type rotor, it is preferable that a magnet unit consisting of a rotor core and a plurality of magnets embedded in the rotor core is assembled to the rotor housing.

In each of the above embodiments, the rotating electric machine has an outer-rotor structure. However, this structure may be changed such that the rotating electric machine may be a rotary electric machine having an inner-rotor structure. In a rotating electric machine with an inner rotor structure, a stator is provided on the radially outer side, and a rotor is provided on the radially inner side. In such a case, similarly to the above configuration, the cylindrical portion and the end plate portion in the rotor housing may be joined to each other with the joint portion on the cylindrical portion side facing on the radially inner side and the joint portion on the end plate portion side facing on radially outer side. Alternatively, the cylindrical portion and the end plate portion may be joined together with the joint portion on the cylindrical portion side facing on the radially outer side and the joint portion on the end plate portion side facing on the radially inner side.

The disclosure in the present specification is not limited to the illustrated embodiments. The disclosure encompasses the illustrated embodiments and modifications based on the embodiments by those skilled in the art. For example, the disclosure is not limited to the combinations of components and/or elements shown in the embodiments. The disclosure may be implemented in various combinations. The disclosure may have additional portions that may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. Several technical scopes disclosed are indicated by descriptions in the claims and should be understood to include all modifications within the meaning and scope equivalent to the descriptions in the claims.

Although the present disclosure is described based on the above embodiment, the present disclosure is not limited to the embodiment and the structure. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. A rotor housing for use in a rotor of a rotating electric machine, comprising:
a cylindrical portion that is cylindrical and holds a magnet of the rotor;
an end plate portion joined to an axial end of the cylindrical portion and to which a shaft serving as a rotating shaft is fixed; and
a cylindrical extension portion provided at an end portion of the cylindrical portion opposite to the end plate portion in an axial direction and extending axially outward beyond an arrangement area of the magnet;
wherein
the cylindrical portion and the end plate portion are each formed as separate bodies and are joined together to form an integrated body, while the cylindrical portion and the cylindrical extension portion are each formed as separate bodies and are joined together to form an integrated body.

2. The rotor housing according to claim 1, wherein
the cylindrical portion and the end plate portion are integrated together with a joint portion on the cylindrical portion side and a joint portion on the end plate portion side being fitted together in a radial direction.

3. The rotor housing according to claim 2, wherein
the magnet is attached to a radially inner side of the cylindrical portion, and
the cylindrical portion and the end plate portion are joined together with a joint portion on the cylindrical portion side facing on a radially outer side and a joint portion on the end plate portion side facing on a radially inner side.

4. The rotor housing according to claim 2, wherein
the magnet is attached to a radially inner side of the cylindrical portion, and
the cylindrical portion and the end plate portion are joined together with a joint portion on the cylindrical portion side facing on a radially inner side and a joint portion on the end plate portion side facing on a radially outer side.

5. The rotor housing according to claim 4, wherein
the end plate portion has an annular portion extending in the axial direction,
the cylindrical portion has a protruding portion protruding on a radially inner side at an axial end thereof, and a circular fitting portion extending in the axial direction is provided at a radial end of the protruding portion, and
the cylindrical portion and the end plate portion are fitted together with the fitting portion, which is a joint portion on the cylindrical portion side, on the radially inner side and the annular portion, which is a joint portion on the end plate portion side, on the radially outer side.

6. The rotor housing according to claim 4, wherein
when the cylindrical portion and the end plate portion overlap each other with the joint portion on the cylindrical portion side facing on a radially inner side and the joint portion on the end plate portion side facing on a radially outer side, the end plate portion overlaps the cylindrical portion and the magnet in the radial direction.

7. The rotor housing according to claim 1, wherein
the cylindrical portion is formed of a magnetic material, and
the end plate portion is made of a material that is non-magnetic and lighter than the cylindrical portion.

8. The rotor housing according to claim 1, wherein
the end plate portion has a disk portion extending in a direction perpendicular to the axial direction, and a shaft fixing portion provided on a radial center side of the disk portion and fixing the shaft, and
the disk portion and the shaft fixing portion are formed separately from each other and are joined together to form an integral body.

9. The rotor housing according to claim 1, wherein
the cylindrical portion and the end plate portion have different thicknesses, and the thickness of the cylindrical portion is greater than the thickness of the end plate portion.

10. The rotor housing according to claim 1, wherein
the cylindrical portion and the end plate portion have different thicknesses, and the thickness of the end plate portion is greater than the thickness of the cylindrical portion.
